(19) United States
(12) Patent Application Publication
(10) Pub. No.: US 2013/0115954 A1
(43) Pub. Date: May 9, 2013

(54) METHOD AND APPARATUS FOR HANDOVER USING PREDICTED VEHICULAR LOCATIONS

(71) Applicants: Gilles Charbit, Farnborough (GB); Matti Kullervo Jokimies, Salo (FI)

(72) Inventors: Gilles Charbit, Farnborough (GB); Matti Kullervo Jokimies, Salo (FI)

(73) Assignee: RENESAS MOBILE CORPORATION, Tokyo (JP)

(21) Appl. No.: 13/289,544

(22) Filed: Nov. 4, 2011

(30) Foreign Application Priority Data
Nov. 3, 2011 (GB) 1119004.8

(51) Int. Cl. H04W 36/36; H04W 36/32

(52) U.S. Cl. 455/437; 455/440

(57) ABSTRACT

A method, apparatus and computer program product are therefore provided according to an example embodiment to distribute and utilize location information received from one or more networks to determine handover timing and target cell selection for a mobile terminal. A method also includes determining a predicted future mobile terminal location based on the location information for the mobile terminal. A method also includes determining at least one network entity with a serving area that encompasses the predicted future mobile terminal location. A method also includes causing the at least one network entity to receive handover instructions by causing the predicted future mobile terminal location and information regarding the at least one network entity to be transmitted to a network management node.

### TECHNOLOGICAL FIELD

Embodiments of the present invention relate generally to intelligent transportation system technology and, more particularly, to utilizing vehicular location information in a cellular system.

### BACKGROUND

Machine type communications in 3rd Generation Partnership Project (3GPP) cellular networks; include vehicular-to-infrastructure systems (together with other traffic-related systems, like vehicle-to-vehicle systems) such as intelligent transportation systems (ITS). Generally, an ITS is configured to automate interactions between vehicles in order to achieve greater levels of safety, security and efficiency. For example, an ITS may enable a mobile terminal on an emergency vehicle to notify surrounding vehicles and/or upcoming traffic of its approach. Advantageously the notification may cause an alert and may even attempt to slow the nearby vehicles to allow for the safe passage of the emergency vehicle. Other embodiments of an ITS may include setting variable speed limits, reporting traffic flow and/or the like.

In order to provide wireless access in ITS and vehicular environments, a vehicle-to-infrastructure system called Wireless Access Vehicular Environment (WAVE) was developed. A WAVE system consists of fixed road side units (RSU) usually positioned along roads and mobile terminals (e.g., on board units or OBUs) mounted in vehicles The RSUs and mobile terminals may form WAVE basic service sets (WBSSs) connected to the Wide Area Network (WAN) via an appropriate portal. Such a portal may be implemented via cable linking the relay node and the WAN, but this may, for example, add significantly to cost of implementing an ITS system. Another version of a WAVE system may be implemented wirelessly over an ITS—Dedicated Short Range Communications (DSRC) system. The ITS-DSRC is customarily deployed over 75 MHz of bandwidth in a relatively high-frequency band around 5.9 GHz in 10-20 MHz channel bandwidth. However, in some use cases, such as ETSI TR 102 898 entitled “Use cases of automotive applications”, v0.4.0, which is hereby incorporated by reference, WAVE standards were characterized as not sufficient to cover requirements for vehicle to roadside use case in automotive machine to machine (M2M) cases.

### BRIEF SUMMARY

A method, apparatus and computer program product are therefore provided according to an example embodiment to distribute and utilize location information received from one or more networks to determine handover timing and target cell selection for a mobile terminal. In some example embodiments, mobile terminal location information and movement information (e.g. change in mobile terminal locations, ITS information or the like) may be combined and used to predict one or more access points and/or relay nodes that may be used in the future by the mobile terminal. The network then may prepare resources to enable the mobile terminal to connect to the one or more access points and/or relay nodes to, for example, cause a connection with minimum air interface signaling overhead and/or a break in the connection.

In this regard, a method is provided that includes determining a predicted future mobile terminal location based on the location information for the mobile terminal. A method also includes determining at least one network entity with a serving area that encompasses the predicted future mobile terminal location. A method also includes causing the determined at least one network entity to receive handover instructions by causing the at least one network entity to receive handover instructions by causing the predicted future mobile terminal location and information regarding the at least one network entity to be transmitted to a network management node.

An example apparatus may include at least one processor and at least one memory storing computer program code, wherein the at least one memory and stored computer program code are configured, with the at least one processor, to cause the apparatus to receive location information for a mobile terminal. The at least one memory and stored computer program code are further configured, with the at least one processor, to cause the apparatus to determine a predicted future mobile terminal location based on the location information for the mobile terminal. The at least one memory and stored computer program code are further configured, with the at least one processor, to cause the apparatus to determine at least one network entity with a serving area that encompasses the predicted future mobile terminal location. The at least one memory and stored computer program code are further configured, with the at least one processor, to cause the apparatus to cause the at least one network entity to receive handover instructions by causing the predicted future mobile terminal location and information regarding the at least one network entity to be transmitted to a network management node.

In a further embodiment, a computer program product is provided that includes at least one non-transitory computer-readable storage medium having computer-readable program instructions stored therein, the computer-readable program instructions includes program instructions configured to receive location information for a mobile terminal. The computer-readable program instructions also include program instructions configured to determine a predicted future mobile terminal location based on the location information for the mobile terminal. The computer-readable program instructions also include program instructions configured to determine at least one network entity with a serving area that encompasses the predicted future mobile terminal location. The computer-readable program instructions also include program instructions configured to cause the at least one network entity to receive handover instructions by causing the predicted future mobile terminal location and information regarding the at least one network entity to be transmitted to a network management node.

One example apparatus may include means for receiving location information for a mobile terminal. The apparatus may also include means for determining, using a processor, a predicted future mobile terminal location based on the location information for the mobile terminal. The apparatus may also include means for determining at least one network entity with a serving area that encompasses the predicted future mobile terminal location. The apparatus may also include means for causing the at least one network entity to receive handover instructions by causing the predicted future mobile terminal location and information regarding the at least one network entity to be transmitted to a network management node.

In this regard, a method is provided that includes causing mobile terminal location information to be transmitted to a Vehicular Location Control Entity (VLCE). A method also includes receiving a predicted mobile terminal location and at least one network entity, wherein the predicted mobile terminal location is within a serving area of the at least one network entity. A method also includes causing a handover command to be transmitted to the at least one network entity.

An example apparatus may include at least one processor and at least one memory storing computer program code, wherein the at least one memory and stored computer program code are configured, with the at least one processor, to cause mobile terminal location information to be transmitted to a VLCE. The at least one memory and stored computer program code are further configured, with the at least one processor, to receive a predicted mobile terminal location and at least one network entity, wherein the predicted mobile terminal location is within a serving area of the at least one network entity. The at least one memory and stored computer program code are further configured, with the at least one processor, to cause a handover commands to be transmitted to the at least one network entity.

In a further embodiment, a computer program product is provided that includes at least one non-transitory computer-readable storage medium having computer-readable program instructions stored therein, the computer-readable program instructions includes program instructions configured to cause mobile terminal location information to be transmitted to a VLCE. The computer-readable program instructions also include program instructions configured to receive a predicted mobile terminal location and at least one network entity, wherein the predicted mobile terminal location is within a serving area of the at least one network entity. The computer-readable program instructions also include program instructions configured to cause a handover commands to be transmitted to the at least one network entity.

One example apparatus may include means for causing mobile terminal location information to be transmitted to a VLCE. The apparatus may also include means for receiving a predicted mobile terminal location and at least one network entity, wherein the predicted mobile terminal location is within a serving area of the at least one network entity. The apparatus may also include means for causing a handover commands to be transmitted to the at least one network entity.

### BRIEF DESCRIPTION OF THE DRAWINGS

Having thus described the example embodiments of the invention in general terms, reference will now be made to the accompanying drawings, which are not necessarily drawn to scale, and wherein:

FIG. 1 is a schematic representation of an example system that may benefit from some example embodiments of the present invention;

FIG. 2 is a block diagram of an example apparatus that may be embodied by an example mobile terminal in accordance with one embodiment of the present invention;

FIG. 3 is a signaling flow diagram according to an embodiment of the present invention;

FIG. 4 illustrates example ITS protocol layering performed by an example mobile terminal in accordance with one embodiment of the present invention;

FIG. 5 is a flow chart illustrating operations performed by an example VLCE in accordance with one embodiment of the present invention; and

FIG. 6 is a flow chart illustrating operations performed by an example MME in accordance with one embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

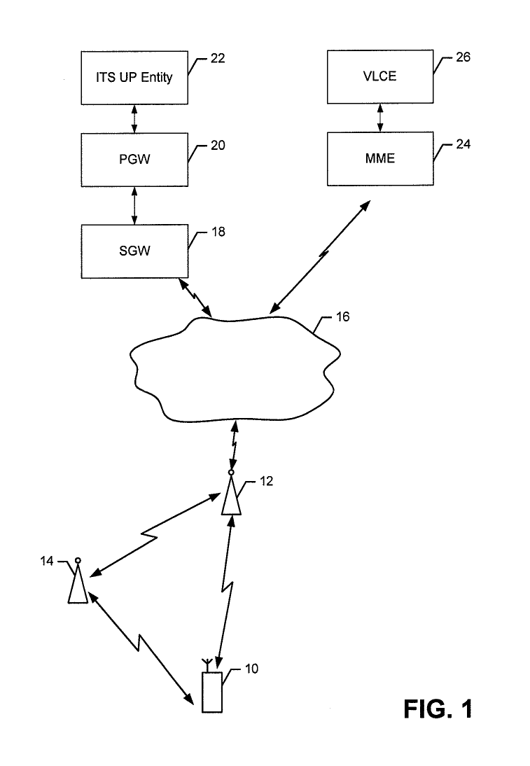

Although the method, apparatus and computer program product may be implemented in a variety of different systems, one example of such a system is shown in FIG. 1, which includes a first communication device (e.g., mobile terminal 10) that is capable of communication via a access point 12, such as a base station, a macro cell, a Node B, a serving cell, an evolved Node B (eNB) or other access point or via an relay node 14 with a network 16 (e.g., a core network). While the network may be configured in accordance with long term evolution (LTE) or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

In an embodiment, a relay node 14 (e.g. RSU, vehicular relay node or the like) may be embodied as a transparent relay, without, for example, a cell ID. The relay node 14 may be configured to perform initial cell access as a special mobile terminal to a macro-cell access point, such as access point 12, within coverage area. For example and as is discussed in LTE release-10, a specified Type 1 non-transparent relay, such as the relay node 14, may achieve downlink synchronization and perform initial cell access procedure over the air as a special mobile terminal. In some example embodiments, the relay node 14 may be a Type II transparent relay. The cell access procedure may also include uplink timing alignment, Radio Resource Control (RRC) connection configuration and/or security activation. In an embodiment and at the end of an initial cell access procedure the relay node 14 may operate in a connected state, such as a RRC_CONNECTED state.

In some example embodiments, a mobile terminal 10 may connect to an access point 12 via a relay node 14 on the user plane and/or the control plane. A mobile terminal 10 may implicitly re-select a relay node 14 without handover in some example embodiments. In addition, there may be a direct link between the mobile terminal 10 and the access point 12, for example, while conducting Release-8 specified initial cell attachment procedures and handover procedures.

The network 16 may include a collection of various different nodes, devices or functions that may be in communication with each other via corresponding wired and/or wireless interfaces. For example, the network may include one or more cells, including access point 12 and/or relay node 14 and which may serve a respective coverage area. The access point 12 could be, for example, part of one or more cellular or mobile networks or public land mobile networks (PLMNs). In turn, other devices such as processing devices (e.g., personal computers, server computers or the like) may be coupled to the mobile terminal 10 and/or other communication devices via the network.

The network 16 may also include and/or may be in communications with a serving gateway (SGW) 18, a Packet Data Networks (PDN) Gateway (PGW) 20, a ITS user plane (UP) entity 22, a network management node such as Mobility Management Entity (MME) 24 and/or a VLCE 26. In some example embodiments, an ITS server and client reside on an application layer and communicate over packet data connections. In further example embodiments a UP ITS platform (not shown) may comprise the ITS UP entity 22. The ITS UP Entity 22 is configured to interface with the PGW 20 over a SGi interface. The ITS UP Entity 22 is also configured to provide data carried for data applications (e.g. road tolling, emergency notification center, traffic management, etc).

In some example embodiments an ITS control plane (CP) may be configured to provide signaling that includes enables the transferring of location information between the UP ITS platform and the mobile terminal 10.

In some embodiments, the VLCE 26, is configured to enable signaling between the mobile terminal 10 and other network entities in the CP (e.g. processes a mobile terminal connection request/response including periodic/event based operations, location info messages, and assistance data for ITS service for example resource configurations for predicted relay nodes and access points within target area of interest referred to as an ITS target area). In some example embodiments, a VLCE 26 is in communication the network 16 via the MME 24.

Alternatively or additionally, the VLCE 26 may be embodied by the MME 24, or another network entity. Further still, in some example embodiments, the VLCE 26 may be embodied by a mobile terminal.

A communication device, such as the mobile terminal 10 (also known as user equipment (UE), vehicular user equipment (V-UE) and/or OBU), may be in communication with other communication devices or other devices via the access point 12, the relay node 14 and, in turn, the network 16. In some cases, the communication device may include an antenna for transmitting signals to and for receiving signals from an access point 12 and/or the relay node 14.

In some example embodiments, the mobile terminal 10 may be a mobile communication device such as, for example, a vehicle-mounted transceiver unit, a mobile telephone, portable digital assistant (PDA), pager, laptop computer, or any of numerous other hand held or portable communication devices, computation devices, content generation devices, content consumption devices, or combinations thereof. As such, the mobile terminal 10 may include one or more processors that may define processing circuitry either alone or in combination with one or more memories. The processing circuitry may utilize instructions stored in the memory to cause the mobile terminal 10 to operate in a particular way or execute specific functionality when the instructions are executed by the one or more processors. The mobile terminal 10 may also include communication circuitry and corresponding hardware/software to enable communication with other devices and/or the network 16.

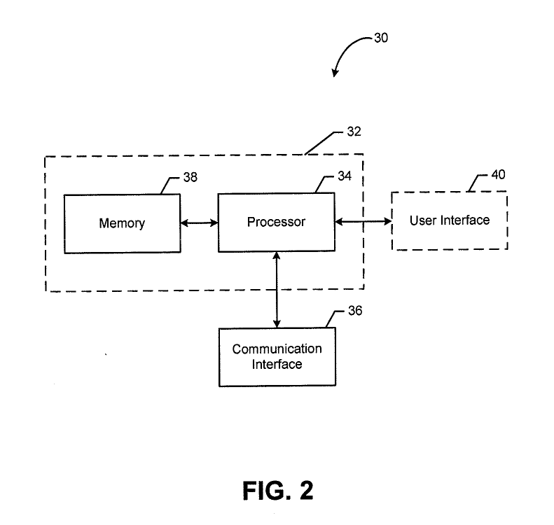

In one embodiment, for example, the mobile terminal 10, the access point 12, the relay node 14, the SGW 18, the PGW 20, the ITS UP entity 22, the MME 24 and/or the VLCE 26 may be embodied as or otherwise include an apparatus 30 as generically represented by the block diagram of FIG. 2. While the apparatus 30 may be employed, for example, by the mobile terminal 10, the access point 12, the relay node 14, the SGW 18, the PGW 20, the ITS UP entity 22, the MME 24 and/or the VLCE 26, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 30 may include or otherwise be in communication with processing circuitry 32 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 38 that may be in communication with or otherwise control a communication interface 36 and, in some cases, a user interface 40. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 40 (if implemented) may be in communication with the processing circuitry 32 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. The apparatus 30 need not always include a user interface. For example, in instances in which the apparatus is embodied as an access point 12 and/or a relay node 14, the apparatus may not include a user interface. As such, the user interface is shown in dashed lines in FIG. 2.

The communication interface 36 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 16 and/or any other device or module in communication with the processing circuitry 32, such as between the mobile terminal 10, the access point 12 and the relay node 14. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 38 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 38 or otherwise accessible to the processor. As such, whether configured by hardware or by a combination of hardware and software, the processor may represent an entity (e.g., physically embodied in circuitry—in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

A method, apparatus and computer program product of an example embodiment of the present invention is configured to distribute and utilize location information gathered by a mobile terminal 10, an ITS UP entity 22, MME 24 and/or from other network entities so as to enable handover and target cell selection as mobile terminal 10 moves throughout an ITS target area. In some embodiments, an ITS system, such as an ITS UP entity 22, may be configured to provide location and event based reporting (tolls, traffic accidents, and/or the like). Mobile terminal 10 may also cause location information (e.g., based on GPS, or where GPS signal is not available, on roadside information or sub-optimally on cell ID and if available on list of periodically scanned WLAN AP by the vehicle) and the predicted movement of the UE (e.g., based on the route determined by the car navigation system) to be delivered to VLCE 26 using for example a LTE ITS Protocol (LIP) protocol. The VLCE 26 may also be configured to receive a predicted route of the mobile terminal (e.g., based on the route determined by a car navigation system or from a navigation system on the mobile terminal) from the mobile terminal 10. Alternatively or additionally, event information may also be provided to the VLCE 26. Event information includes but is not limited to, status of a vehicle (e.g. door open, gas being added, etc.), current route in a navigation system, current destination, number of occupants in the vehicle, a calendar entry and/or the like.

The VLCE 26 is further configured to receive, such as by a communications interface 36, location based information and/or event information from one or more network entities (e.g. a mobile terminal 10, an access point 12, a relay node 14, an ITS UP entity 22 and/or the like). In instances in which an ITS UP entity 22 is providing reporting information and in some example embodiments, the VLCE 26 may be connected to an ITS system such as a WAVE system. Alternatively or additionally, an ITS system such as the ITS system described in co-pending application entitled “Cellular Assisted Intelligent Transport System”, Gilles Charbit, Matti Jokimies, which is hereby incorporated by reference, may also connect to or otherwise be in communications with the VLCE 26.

Each ITS system generally is configured, for example, to perform handover for mobile terminals that are traveling at a high rate of speed, thus resulting in a larger amount of handover related signaling. Additionally, resource reservations (in the prepared target RSU and/or access point) need to be conducted early enough so that they are available at the time of handover. If the handover preparation and handover decision is done to a wrong cell, or at the wrong time, resources may then be wasted. Handover, in some embodiments, may also include a network assisted mobile terminal cell changes. Thus the VLCE 26, for example, may advantageously allow for the preparation of network entities (e.g. an access point 12, a relay node 14 or the like) such that resource (e.g. air interface signaling overhead and breaks in connections) waste is reduced.

In some example embodiments, the VLCE 26, may be configured, such as by using a processor 34, or the like to determine geographical serving areas for one or more access points 12 and/or relay nodes 14. Based on the determined geographical serving areas, the processor 34 or the like may then map a future predicted location of a mobile terminal to a geographical serving area of an access point 12 or a relay node 14. The VLCE 26, may be then configured, such as by using a processor 34, the communications interface 36 or the like to cause location, event information and/or the determined access point 12 or relay node 14 to be transmitted to the MME 24. The MME 24 may then in turn be configured to cause handover commands and/or requests for access point 12 and/or relay nodes 14 to be prepared so that cell change may occur.

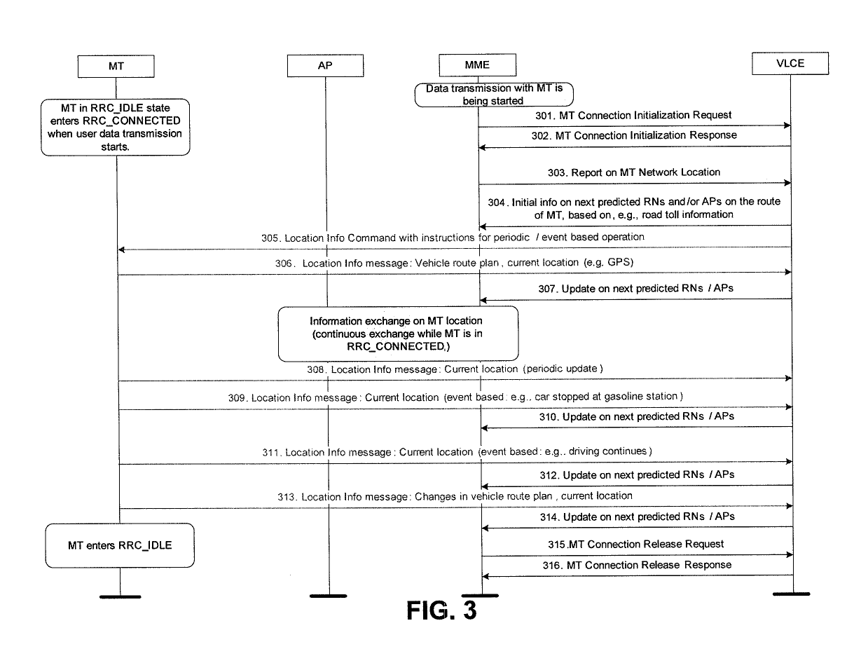

FIG. 3 illustrates an example overview signaling diagram according to some example embodiments of the present invention. As is shown in signals 301 and 302, in an instance in which a mobile terminal, such as mobile terminal 10, enters an RRC_CONNECTED state from RRC_IDLE state, then a connection between MME 24 and VLCE 26 for the mobile terminal 10 is initialized. Each time a mobile terminal enters an RRC_CONNECTED state a new connection may be formed for that particular mobile terminal. In some example embodiments, the connection initialization informs the VLCE 26 that location information for a specific mobile terminal should be transmitted to the MME 24 at least periodically and also instructs the MME 24 to deliver information about the mobile terminal location in the network, such as network 16, to the VLCE 26. Such signaling between the MME 24 and the VLCE 26, such as via communications interface 36, may occur via a point to point protocol such (e.g. SIs protocol).

At signal 303, MME 24 may be configured to report continuously and/or periodically on the mobile terminal location. In some instances, MME 24 may report a location of the mobile terminal in a wireless and/or cellular network, such as network 16, to the VLCE 26. The VLCE 26 may then be configured to combine mobile terminal location information received from at least the mobile terminal 10 and/or the MME 24. Based on the received location information, the VLCE 26 may then determine the location of the mobile terminal and then predict the future movement of the mobile terminal 10.

At signal 304, the VLCE 26, using the processor 34, the communications adapter 38 or the like, may cause a message containing the next predicted mobile terminal location in terms of access point and relay nodes to be transmitted. As is described herein, the VLCE 26 is configured to determine, such as by using the processor 34, the geographical serving area of the connected access points and relay nodes. In other words location information is transmitted to the MME 24 in terms of network entities. In alternate embodiments, location information may be sent in coordinate form so as to enable MME 24 to determine next access points and relay nodes.

At signal 305, a mobile terminal, such as mobile terminal 10, may be instructed to cause location information to be delivered to the VLCE 26. The delivery may be periodic (e.g., once in 2 minutes), and/or based on events. Events can be, for example, that the car has stopped and door opened, there is longer vehicle stop (e.g. greater than five minutes), or the vehicle route in the navigation system has changed. Also lower speed due to traffic, or roadside information, which is relevant to the prediction of the movement of the vehicle (like speed limits, especially those not known in the navigation system), may also be provided to the VLCE 26 by the mobile terminal 10, the MME 24 or the like. At signal 36, location and route information is delivered to the VLCE 26 by the mobile terminal 10.

After the VLCE 26 has received, such as via the communications interface 36, location information, the VLCE 26, using for example the processor 34, processes the location information to calculate a predicted access point 12 and/or relay node 14 that the mobile terminal may access in the future. At signal 307, the next predicted access point 12 and/or relay node 14 is caused to be delivered to MME 24.

Signals 308-314 illustrate example transmissions according to some example embodiments of the present invention. For example, signal 308 illustrates a periodic update providing location information from a mobile terminal 10 to the VLCE 26. Location updates may be sent at a regular interval, such as every 10 minutes, or every 10 seconds. Signals 309 and 311 illustrate location messages based on event (e.g. car stopped a gasoline station or resuming driving after a stop). Signals may also be sent based on an event. In response to signals 309 and 311, the VLCE 26 may provide the MME 24 with updated next predicted access point 12 and relay nodes 14. At signal 313 the mobile terminal 10 may transmit a change in a route plan from a previously calculated route, thus causing the VLCE 26 to update the next predicted access point 12 and/or relay node 14.

As shown in signals 315 and 316, in an instance in which a mobile terminal, such as mobile terminal 10, enter RRC_IDLE, the connection between MME 24 and VLCE 26 may be released. The information related to the particular mobile terminal in the VLCE 26 may also be cleared. Alternatively or additionally, the information related to the mobile terminal may kept for some time, in order to have better initial information, if the mobile terminal starts a new session soon after the previous one.

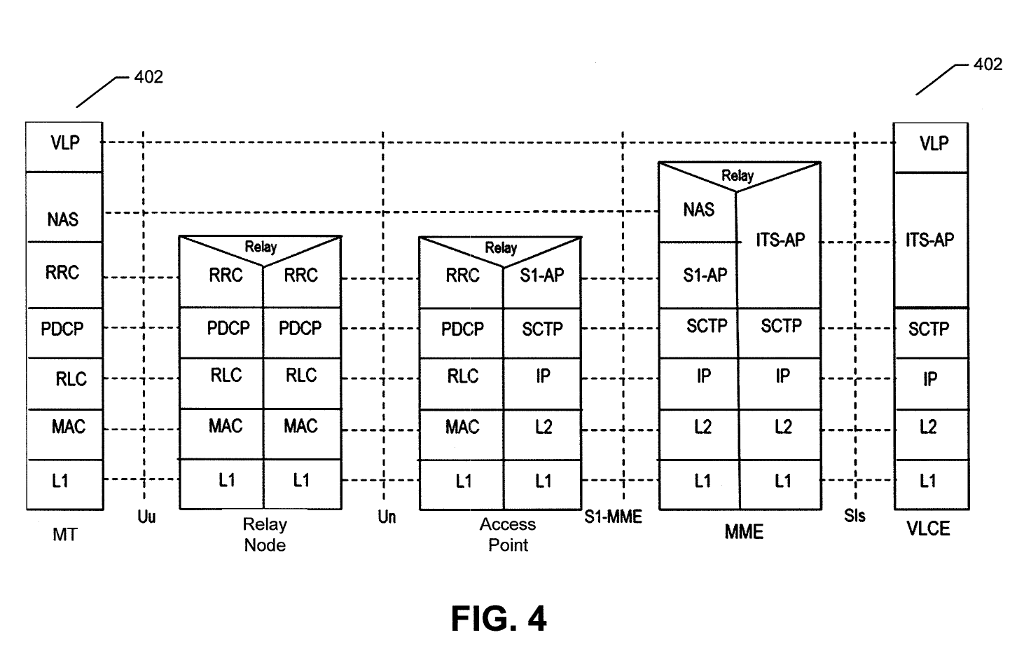

FIG. 4 illustrates example ITS protocol layering for ITS Packet Data Units (PDUs) transfer between the V-UE and the VLCE according to some example embodiments of the present invention. A Vehicular Location Protocol (VLP) 402 may be used for signaling of ITS data. VLP 402, in some example embodiments, is configured to be a Point-to-Point protocol between a mobile terminal 10 and VLCE 26 for mobile terminal initiated or mobile terminal terminated ITS messages being encapsulated in the underlying protocol messages. See for example signals 305, 306, 308, 309, 311 and 313 of FIG. 3. A mobile terminal may also be a special mobile terminal using Enhanced Universal Mobile Telecommunications System (UMTS) Terrestrial Radio Access Network (E-UTRAN) protocols, for example by using VLP, SIP or the like. As described herein, a relay node may be seen as a transparent relay interfacing with the mobile terminal and the relay node for Access Startum (AS) signaling exchange and RRC signaling.

In an example embodiment, the VLP 402 may use Evolved Packet Core (EPC) control plane (CP) protocols as underlying transport. The VLP messages on the CP may be encapsulated in the underlying protocol messages, e.g. ITS Application Protocol (ITS-AP) PDU protocol messages between VLCE 26 and MME 24 and/or Non-Access Stratum (NAS) PDU between the MME 24 and a mobile terminal (NAS messages are encapsulated in S1 Application Protocol (S1AP) messages between MME 24 and access point 12, and in RRC (download (DL)/upload (UL) information transfer) messages between the access point 12 and mobile terminal 10 and in some example embodiments via relay node 14. In some example embodiments, the VLP 402 may also be used in an instance in which a mobile terminal 10 is directly connected to access point 12 via direct link rather than via a relay node.

The SIs interface, such as the SIs interface between the VLCE 26 and the MME 24, may be used as, but is not limited to 1) a transport link for the VLP 402 and/or 2) for exchange of messages between MME 24 and VLCE 26. The S1-AP protocol, terminated between the MME 24 and an access point 12, may be used as a transport for LIP messages over the S1-MME interface.

In some example embodiments, once UP bearer is setup (e.g. Data Radio Bearer), ITS data transfer may take place on UP. This may then allow ITS information to be used by ITS-based applications—e.g. road tolling, emergency recovery, and/or the like. ITS information may be received by the VLCE 26 and used to determine a predicted next location for a mobile terminal 10. Alternatively or additionally, VLCE 26 functionality may be integrated in MME 24.

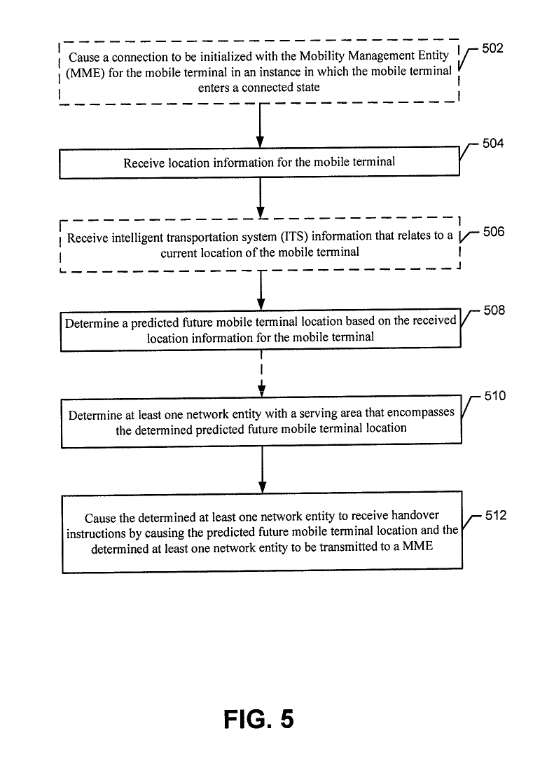

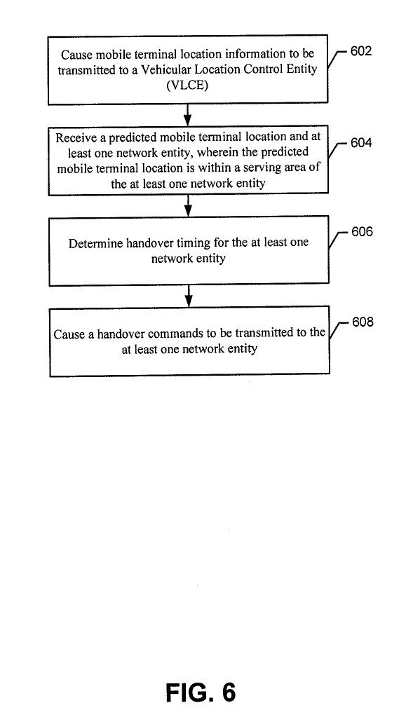

FIGS. 5-6 illustrate example operations performed by a method, apparatus and computer program product, such as apparatus 30 of FIG. 2 in accordance with one embodiment of the present invention are illustrated. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 38 of an apparatus employing an embodiment of the present invention and executed by a processor 34 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 5-6, when executed, convert a computer or processing circuitry into a particular machine configured to perform an example embodiment of the present invention. Accordingly, the operations of FIGS. 5-6 define an algorithm for configuring a computer or processing circuitry 32, e.g., processor, to perform an example embodiment. In some cases, a general purpose computer may be provided with an instance of the processor which performs the algorithm of FIGS. 5-6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included (some examples of which are shown in dashed lines in FIG. 5). It should be appreciated that each of the modifications, optional additions or amplifications below may be included with the operations above either alone or in combination with any others among the features described herein.

FIG. 5 is a flow chart illustrating operations performed by an example VLCE in accordance with one embodiment of the present invention. As shown in operation 502, the apparatus 30 embodied, for example, by a VLCE 26, may include means, such as the processing circuitry 32, the processor 34, the communications interface 26 or the like, for causing a connection to be initialized with the MME 24 for a mobile terminal in an instance in which the mobile terminal enters a connected state (e.g. RRC_CONNECTED). See signal 301 and 302 in FIG. 3. Once connected, the VLCE 26 may be configured to receive, such as via a communications interface 36, location information for the mobile terminal. See operation 504. Such location information may be received from the mobile terminal 10, the access point 12, the relay node 14, ITS UP entity 22 and/or the MME 24. The VLCE 26 may also receive, such as via the communications interface 36, ITS information that relates to a current location of the mobile terminal. See operation 506.

As shown in operation 508, the apparatus 30 embodied, for example, by a VLCE 26, may include means, such as the processing circuitry 32, the processor 34 or the like, for determining a predicted future mobile terminal location based on the location information for the mobile terminal. A predicted mobile terminal location may be based on a received navigation route, a direction and speed of travel, known destination, or the like. Based on the determined predicted future mobile terminal location and based on determined geographical serving areas for a network entity (e.g. access point 12 and/or relay node 14), the VLCE, such as by the processor 34, determines at least one network entity with a serving area that encompasses the predicted future mobile terminal location. See operation 510. The VLCE 24 may be configured to determine the geographical serving areas of one or more network entities or may have known geographical serving areas stored in a memory, such as memory 38. As is shown in operation 512, the apparatus 30 embodied, for example, by a VLCE 26, may include means, such as the processing circuitry 32, the processor 34, the communications interface 26 or the like, for causing the at least one network entity to receive handover instructions by causing the predicted future mobile terminal location and information regarding the at least one network entity to be transmitted to a network management node.

FIG. 6 is a flow chart illustrating operations performed by an example MME in accordance with one embodiment of the present invention. As shown in operation 502, the apparatus 30 embodied, for example, by a MME 24, may include means, such as the processing circuitry 32, the processor 34, the communications interface 26 or the like, for causing mobile terminal location information to be transmitted to a Vehicular Location Control Entity (VLCE). In response, the MME 24 receives, via communications interface 36, a predicted mobile terminal location and at least one network entity, wherein the predicted mobile terminal location is within a serving area of the at least one network entity. See operation 604. The VLCE 26 may be configured, such as by using a processor 34, or the like to determine whether a mobile terminal is currently within a vehicle based on at least one of rate of travel of the mobile terminal, mobile terminal capability signaling or subscription information. For example, determining whether the mobile terminal is in a vehicle is based on but not limited to AS or NAS level mobile terminal capability signaling, subscription information, and/or known because a mobile terminal supports the ITS related signaling. Alternatively or additionally, in an instance in which a mobile terminal is moving rapidly within a macro cell or across smaller cells.

The MME 24 may then be configured to determine, using for example the processor 34, handover timing and cause, such as by the processor 34, the communications interface 36 or the like, handover commands to be transmitted to the at least one network entity (e.g. access point 12 and/or relay node 14). See operations 606-608.

Advantageously, the apparatus 30, method and computer program product as described herein minimizes ITS impact on the core network with the VLCE being responsible for the ITS-specific signaling on the control plane, while maximizing the use of the location information for the mobile terminal mobility management (and hence, handovers are optimized).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving location information for a mobile terminal;
determining, using a processor, a predicted future mobile terminal location based on the location information for the mobile terminal;
determining at least one network entity with a serving area that encompasses the predicted future mobile terminal location; and
causing the at least one network entity to receive handover instructions by causing the predicted future mobile terminal location and information regarding the at least one network entity to be transmitted to a network management node.

2. A method of claim 1 further comprising:
receiving at least one of updated location information from the mobile terminal; and
determining another predicted future mobile terminal location based on the at least one of the received updated location information or event information.

3. A method of claim 1 further comprising determining whether the mobile terminal is currently within a vehicle based on at least one of rate of travel of the mobile terminal, mobile terminal capability signaling or subscription information.

4. A method of claim 1, further comprising determining a geographical serving area for the at least one network entity, wherein the at least one network entity is at least one of an access point or a relay node.

5. A method of claim 1, further comprising receiving event information for a mobile terminal, wherein event information comprises at least one of a navigation system route, roadside information, traffic information, speed limit predications or vehicle information.

6. A method of claim 1 further comprises receiving intelligent transportation system (ITS) information that relates to a current location of the mobile terminal; and determining another predicted mobile terminal location based on the received ITS information.

7. A method of claim 1 wherein location information for the mobile terminal is received while the mobile terminal is in a connected state.

8. A method of claim 7 further comprising in an instance in which the mobile terminal enters a connected state, causing a connection to be initialized with the network management node for the mobile terminal.

9. A method of claim 1 wherein location information is a received from at least one of the mobile terminal via a cellular network and an intelligent transportation system (ITS).

10. An apparatus comprising:
a processor and
a memory including software, the memory and the software configured to, with the processor, cause the apparatus to at least:
receive location information for a mobile terminal;
determine a predicted future mobile terminal location based on the location information for the mobile terminal;
determine at least one network entity with a serving area that encompasses the predicted future mobile terminal location; and
cause the at least one network entity to receive handover instructions by causing the predicted future mobile terminal location and information regarding the at least one network entity to be transmitted to a network management node.

11. An apparatus of claim 10 wherein the at least one memory including the computer program code is further configured to, with the at least one processor, cause the apparatus to:
receive at least one of updated location information or event information from the mobile terminal; and
determine another predicted future mobile terminal location based on the at least one of updated location information or event information.

12. An apparatus of claim 10, wherein the at least one memory including the computer program code is further configured to, with the at least one processor, cause the apparatus to determine whether a mobile terminal is currently within a vehicle based on at least one of rate of travel of the mobile terminal, mobile terminal capability signaling or subscription information.

13. An apparatus of claim 10, wherein the at least one memory including the computer program code is further configured to, with the at least one processor, cause the apparatus to determine a geographical serving area for the at least one network entity, wherein the at least one network entity is at least one of an access point or a relay node.

14. An apparatus of claim 10, wherein the at least one memory including the computer program code is further configured to, with the at least one processor, cause the apparatus to receive event information for a mobile terminal, wherein event information comprises at least one of a navigation system route, roadside information, traffic information, speed limit predications or vehicle information.

15. An apparatus of claim 10 wherein the at least one memory including the computer program code is further configured to, with the at least one processor, cause the apparatus to receive intelligent transportation system (ITS) information that relates to a current location of the mobile terminal; and determine another predicted mobile terminal location based on the received ITS information.

16. An apparatus of claim 10 wherein location information for the mobile terminal is received while the mobile terminal is in a connected state.

17. An apparatus of claim 16 wherein the at least one memory including the computer program code is further configured to, with the at least one processor, cause the apparatus to cause a connection to be initialized with the Mobility Management Entity (MME) for the mobile terminal in an instance in which the mobile terminal enters a connected state.

18. An apparatus of claim 10 wherein location information is a received from a mobile terminal via the cellular network and an intelligent transportation system (ITS).

19. A method comprising:
causing mobile terminal location information to be transmitted to a Vehicular Location Control Entity (VLCE);
receiving a predicted mobile terminal location and at least one network entity, wherein the predicted mobile terminal location is within a serving area of the at least one network entity;
determining, using a processor, handover timing for the at least one network entity; and
causing a handover command to be transmitted to the at least one network entity.

20. The method of claim 18 wherein handover timing is determined based on the received predicted mobile terminal location and network location information.
